(19) United States
(12) Patent Application Publication
(10) Pub. No.: US 2021/0278977 A1
(43) Pub. Date: Sep. 9, 2021

(54) METHOD AND SYSTEM FOR PERFORMING DATA DEDUPLICATION AND COMPRESSION IN A DATA CLUSTER

(71) Applicant: Dell Products L.P., Hopkinton, MA (US)

(72) Inventors: Dharmesh M. Patel, Round Rock, TX (US); Ravikanth Chaganti, Bangalore (IN); Rizwan Ali, Cedar Park, TX (US)

(21) Appl. No.: 16/810,932

(22) Filed: Mar. 6, 2020

(51) Int. Cl. G06F 3/06; G06F 11/10

(52) U.S. Cl. CPC G06F 3/0619; G06F 3/0608; G06F 11/1032; G06F 3/067; G06F 3/0683; G06F 3/0652

(57) ABSTRACT

In general, the invention relates to a method for storing data. The method includes obtaining data from a host, making a first determination that a data cluster comprises a plurality of non-volatile memory devices, based on the first determination: storing processed data corresponding to the data in at least one of the plurality of non-volatile memory devices, and making a second determination to de-stage at least a portion of the processed data to a persistent storage device, and based on the second determination, initiating a delayed compression operation on the processed data.

### BACKGROUND

Computing devices may include any number of internal components such as processors, memory, and persistent storage. Each of the internal components of a computing device may be used to generate data. The process of generating and storing data may utilize computing resources of the computing devices such as processing and storage.

### SUMMARY

In general, in one aspect, the invention relates to a method for storing data. The method includes obtaining data from a host, making a first determination that a data cluster comprises a plurality of non-volatile memory devices, based on the first determination: storing processed data corresponding to the data in at least one of the plurality of non-volatile memory devices, and making a second determination to de-stage at least a portion of the processed data to a persistent storage device, and based on the second determination, initiating a delayed compression operation on the processed data.

In general, in one aspect, the invention relates to a system that includes a processor and a data processor, which when executed by the processor performs a method. The method comprises obtaining data from a host, making a first determination that a data cluster comprises a plurality of non-volatile memory devices, based on the first determination: storing processed data corresponding to the data in at least one of the plurality of non-volatile memory devices, and making a second determination to de-stage at least a portion of the processed data to a persistent storage device, and based on the second determination, initiating a delayed compression operation on the processed data.

In general, in one aspect, the invention relates to a non-transitory computer readable medium which includes computer readable program code, which when executed by a computer processor enables the computer processor to perform a method. The method includes obtaining data from a host, making a first determination that a data cluster comprises a plurality of non-volatile memory devices, based on the first determination: storing processed data corresponding to the data in at least one of the plurality of non-volatile memory devices, and making a second determination to de-stage at least a portion of the processed data to a persistent storage device, and based on the second determination, initiating a delayed compression operation on the processed data.

### BRIEF DESCRIPTION OF DRAWINGS

FIG. 1A shows a diagram of a system in accordance with one or more embodiments of the invention.

FIG. 1B shows a diagram of a data cluster in accordance with one or more embodiments of the invention.

FIG. 1C shows a diagram of a data node with a compute acceleration device in accordance with one or more embodiments of the invention.

FIG. 1D shows a diagram of a data node with a non-volatile memory device in accordance with one or more embodiments of the invention.

FIG. 1E shows a diagram of a data node with no hardware accelerators in accordance with one or more embodiments of the invention.

FIG. 2 shows a diagram of storage metadata in accordance with one or more embodiments of the invention.

FIG. 3A shows a flowchart for storing data in accordance with one or more embodiments of the invention.

FIGS. 3B and 3C show flowcharts for storing data in a system that includes hardware accelerators in accordance with one or more embodiments of the invention.

FIG. 3D shows a flowchart for storing data in a system that does not include hardware accelerators in accordance with one or more embodiments of the invention.

FIGS. 4A-4D show examples in accordance with one or more embodiments of the invention.

FIG. 5 shows a computing system in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to method and system for storing data and metadata in a data cluster. More specifically, embodiments of the invention relate to processing data obtained from a host based on protection policies and the hardware capabilities of the data cluster. Further, the data cluster may include components that have hardware accelerators. The hardware accelerators may be compute acceleration devices or non-volatile memory devices. Embodiments of the invention may include a data processor which may perform and/or initiate one or more data processing operations on the obtained data to generate processed data based on the included hardware of the system and at least one protection policy. The data processing operations may include replication, erasure coding, deduplication, and/or delayed compression.

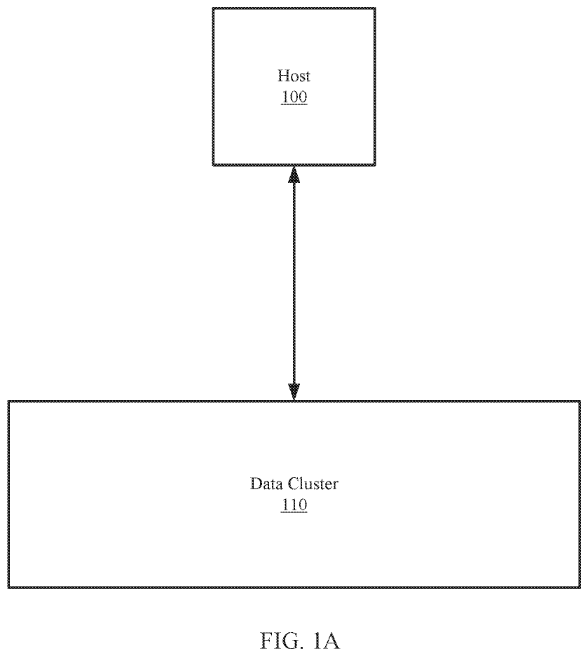

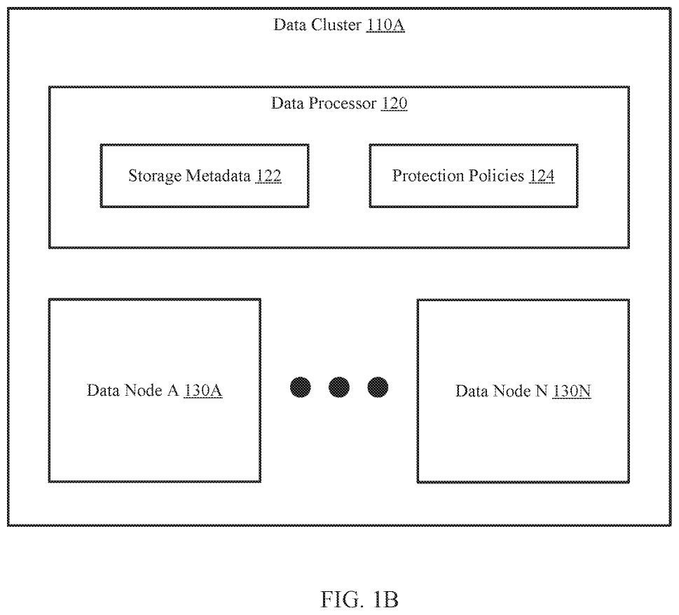

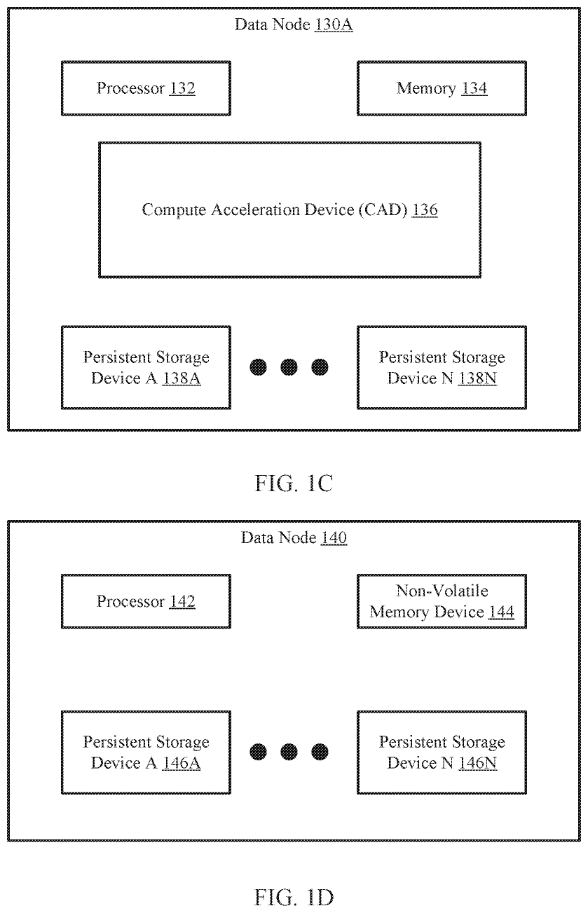

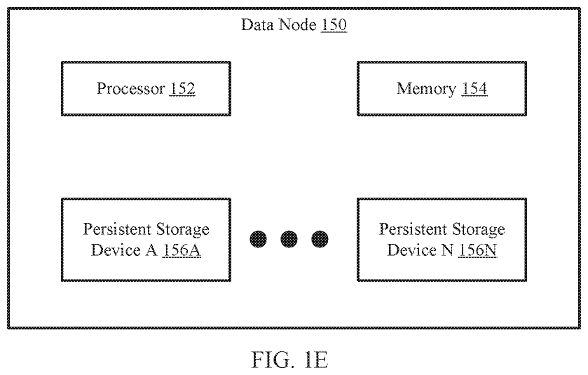

FIG. 1A shows an example system in accordance with one or more embodiments of the invention. The system includes a host (100) and a data cluster (110). The host (100) is operably connected to the data cluster (110) via any combination of wired and/or wireless connections.

In one or more embodiments of the invention, the host (100) utilizes the data cluster (110) to store data. The data stored may be backups of databases, files, applications, and/or other types of data without departing from the invention.

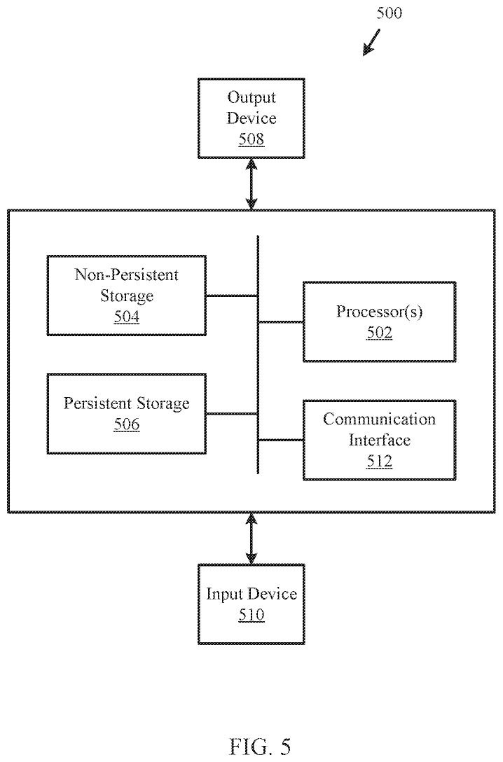

In one or more embodiments of the invention, the host (100) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the host (100) described throughout this application.

In one or more embodiments of the invention, the host (100) is implemented as a logical device. The logical device may utilize the computing resources of any number of computing devices and thereby provide the functionality of the host (100) described throughout this application.

In one or more embodiments of the invention, the data cluster (110) stores data, metadata, and/or backups of data generated by the host (100). The data and/or backups may be deduplicated versions of data obtained from the host (100) obtained via data deduplication. The data cluster (110) may, via an erasure coding operation, store portions of the deduplicated data across data nodes operating in the data cluster (110). Additionally, the data cluster (110) may generate and store replicas of data obtained from the host (100) via data replication. Finally, the data cluster (110) may compress the data obtained from the host (100) via data compression.

As used herein, deduplication refers to methods of storing only portions of files (also referred to as file segments or segments) that are not already stored in persistent storage. For example, when multiple versions of a large file, having only minimal differences between each of the versions, are stored without deduplication, storing each version will require approximately the same amount of storage space of a persistent storage. In contrast, when the multiple versions of the large file are stored with deduplication, only the first version of the multiple versions stored will require a substantial amount of storage. Once the first version is stored in the persistent storage, the subsequent versions of the large file subsequently stored will be de-duplicated before being stored in the persistent storage resulting in much less storage space of the persistent storage being required to store the subsequently stored versions when compared to the amount of storage space of the persistent storage required to store the first stored version.

In one or more embodiments of the invention, an erasure coding procedure includes dividing the obtained data into portions, referred to as data chunks. Each data chunk may include any number of data segments associated with the obtained data. The individual data chunks may then be combined (or otherwise grouped) into data slices (also referred to as Redundant Array of Independent Disks (RAID) slices). One or more parity values are then calculated for each of the aforementioned slices. The number of parity values may vary based on the erasure coding algorithm that is being used as part of the erasure coding procedure. The chunks of a data slice may then be stored across different data nodes in a data cluster. Any chunk within a data slice may be reconstructed using the other chunks in the data slice. Non-limiting examples of erasure coding algorithms are RAID-3, RAID-4, RAID-5, and RAID-6. Other erasing coding algorithms may be used without departing from the invention.

In one or more embodiments of the invention, data compression refers to methods of reducing the number of bits needed to represent data. Data compression may save storage capacity and decrease costs for storage hardware and network bandwidth. Non-limiting examples of data compression algorithms are run-length encoding (RLE), Huffman coding, LZ77, and LZ78 algorithms. Other data compression algorithms may be used without departing from the invention.

In one or more embodiments of the invention, data replication refers to copying data to obtain replicas and storing the replicas in different storage devices. For example, a file may be replicated resulting in two copies (also referred to as “replicas”) of the original file. The original file and the two replicas may then be individually stored in three separate data nodes. Data replication may improve data availability.

Continuing with the discussion of FIG. 1A, the data cluster (110) may include persistent storage devices found within data nodes that each store any number of portions of data. The portions of data may be obtained by other persistent storage devices, data nodes, or the host (100). For additional details regarding the data cluster (110), see, e.g., FIG. 1B.

FIG. 1B shows a diagram of a data cluster in accordance with one or more embodiments of the invention. The data cluster (110A) may be an embodiment of the data cluster (110, FIG. 1A) discussed above. The data cluster (110A) may include a data processor (120), and any number of data nodes (130A, 130N). The components of the data cluster (110A) may be operably connected via any combination of wired and/or wireless connections. Each of the aforementioned components is discussed below. The data cluster (110A) may include other and/or additional components without departing from the invention.

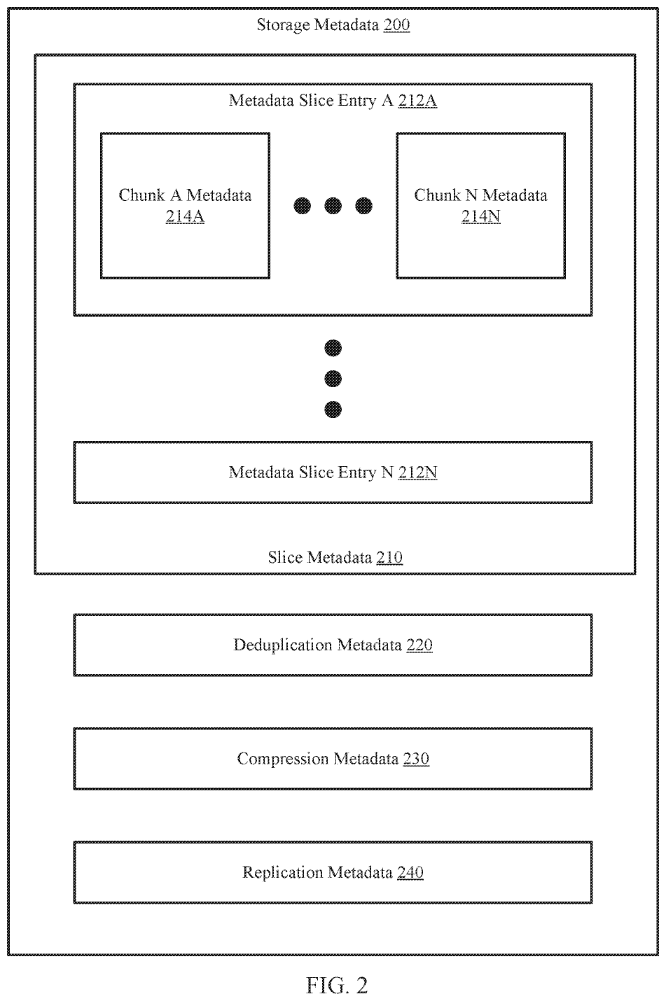

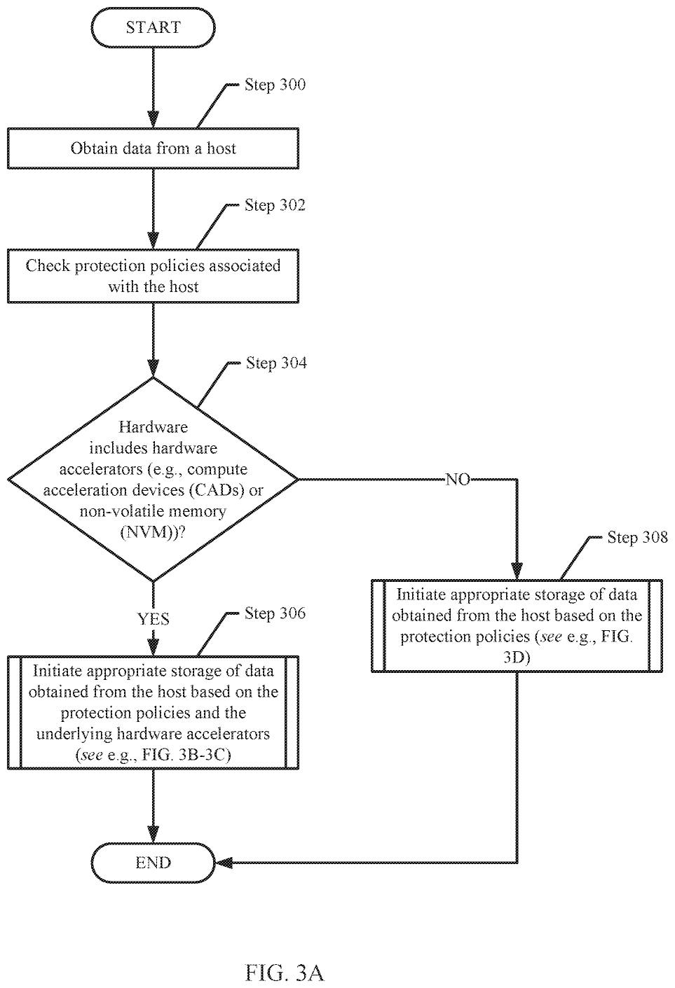

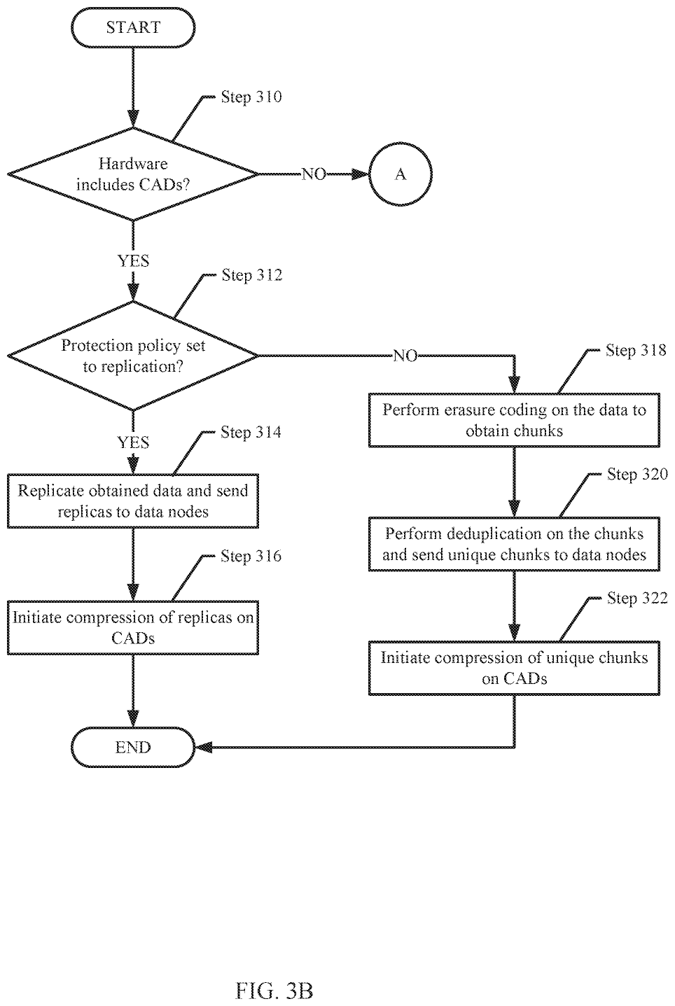

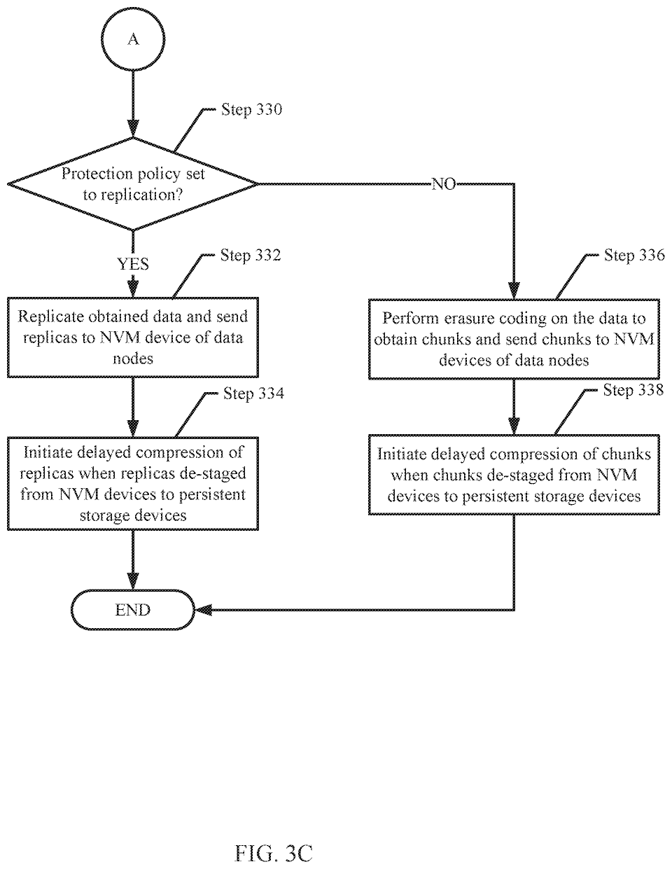

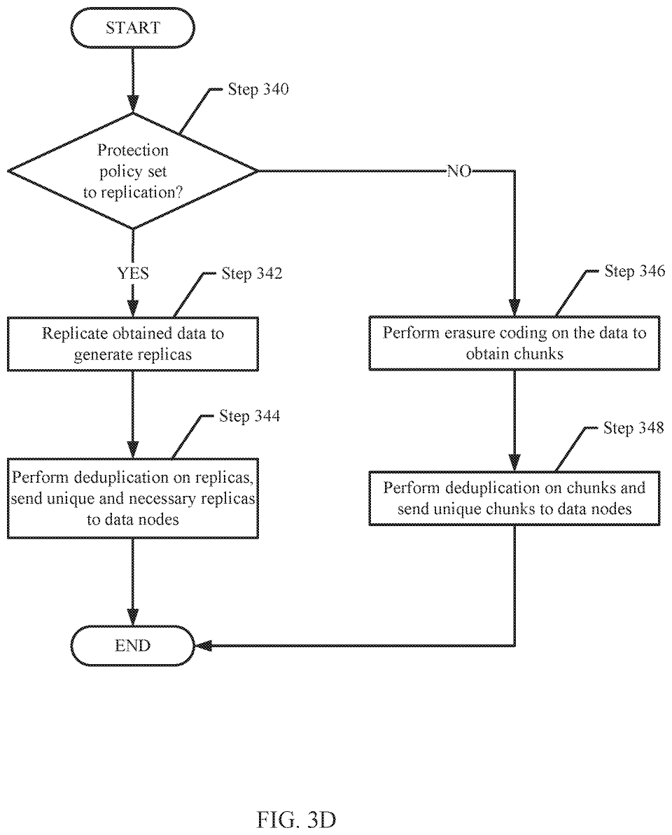

In one or more embodiments of the invention, the data processor (120) is a device (physical or logical) that includes the functionality to perform erasure coding, deduplication, replication and/or initiate compression on data obtained from a host (e.g., 100, FIG. 1A) and manage the storage of the resulting processed data in to the persistent storage devices of data nodes (130A, 130N) in the data cluster (110A). The data processor (120) may perform some or all of the storage management and data processing operations via the methods illustrated in FIGS. 3A-3D. The data processor (120) may generate, utilize, and update storage metadata (122) as part of its storage management and data processing functionality. For additional details regarding the storage metadata (122), refer to FIG. 2.

The data processor may utilize protection policies (124) to determine which data processing operations to perform on data obtained from the host (100, FIG. 1A). The protection policies (124) may be data structures obtained from the host (100, FIG. 1A) that indicate objectives and/or goals for data obtained from the host (100, FIG. 1A). The protection policies (124) may indicate whether to perform erasure coding or replication on data obtained from the host (100, FIG. 1A) as depicted in FIGS. 3B-3D. The protection policies (124) may indicate other and/or additional objectives and/or goals for data obtained from the host (100, FIG. 1A) without departing from the invention.

In one or more of embodiments of the invention, the data processor (120) is implemented as computer instructions, e.g., computer code, stored on a persistent storage device of a data node (130A, 130N) that when executed by a processor of a data node (e.g., 130A, 130N) cause the data node (130A, 130N) to provide the aforementioned functionality of the data processor (120) described throughout this application and/or all, or a portion thereof, of the methods illustrated in FIGS. 3A-3D.

In one or more embodiments of the invention, the data processor (120) is implemented as a computing device (see e.g., FIG. 5), which is operatively connected to (but is separate from) the data nodes in the data cluster. The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data processor (120) described throughout this application and/or all, or a portion thereof, of the methods illustrated in FIGS. 3A-3D.

In one or more embodiments of the invention, the data processor (120) is implemented as a logical device. The logical device may utilize the computing resources of any number of computing devices and thereby provide the functionality of the data processor (120) described throughout this application and/or all, or a portion thereof, of the methods illustrated in FIGS. 3A-3D.

In one or more embodiments of the invention, the data nodes (130A, 130N) store processed data (as described below). The data nodes (130A, 130N) may include persistent storage devices (e.g., 138A, 138N, FIG. 1C) that may be used to store the processed data and/or storage metadata. The management of the processed data is described below with respect to FIGS. 3A-3D. The data nodes (130A, 130N) may include hardware accelerators that improve the computational capabilities of the data nodes (130A, 130N). The hardware accelerators may include compute acceleration devices (CADs) or non-volatile memory (NVM) devices. For additional details regarding the data nodes (130A, 130N), see, e.g., FIGS. 1C-1E.

In one or more embodiments of the invention, each data node (130A, 130N) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data node (130A, 130N) described throughout this application.

In one or more embodiments of the invention, each of the data nodes (130A, 130N) is implemented as a logical device. The logical device may utilize the computing resources of any number of computing devices and thereby provide the functionality of the data nodes (130A, 130N) described throughout this application. For additional details regarding the data nodes (130A, 130N), see, e.g., FIGS. 1C-1E.

FIG. 1C shows a diagram of a data node with a compute acceleration device in accordance with one or more embodiments of the invention. The data node may be an embodiment of the data nodes (130A, 130N, FIG. 1B) discussed above. The data node (130A) may include a processor (132), memory, a compute acceleration device(s) (CAD(s)) (136), and one or more persistent storage devices (138A, 138N). Each component of the data node (130A) may be operatively connected to each other via wired and/or wireless connections. The data node (130A) may have additional, fewer, and/or different components without departing from the invention. Each of the illustrated components of the data node (130A) is discussed below.

In one or more embodiments of the invention, the processor (132) is a component that processes data and processes requests. The processor (132) may be, for example, a central processing unit (CPU). The processor (132) may be other types of processors without departing from the invention. The processor (132) may process a request to store data and/or metadata and process data and/or metadata using data stored in memory (134), the persistent storage devices (138A, 138N), and/or other data nodes (e.g., 130N, FIG. 1B). The processor (132) may process other requests without departing from the invention.

In one or more embodiments of the invention, the data node (130A) includes memory (134), which stores data that is more accessible to the processor (132) than the persistent storage devices (138A, 138N). The memory (134) may be volatile storage. Volatile storage may be storage that stores data that is lost when the storage loses power. The memory (134) may be, for example, Random Access Memory (RAM). In one or more embodiments of the invention, a copy of the data and/or parity chunks required for a persistent storage device rebuilding operation are stored in the memory (134) of the data node (130A).

In one or more embodiments of the invention, the CAD (136) includes functionality to perform data compression initiated by the data processor (120, FIG. 1B) on data obtained from the host (100, FIG. 1A) as depicted in FIG. 3B. The CAD (148) may also include functionality to store data in the persistent storage devices (138A, 138N). In this manner, the data node (130A) and the data processor (120, FIG. 1B) are able to process read and write requests, and process data obtained from the host while the CAD (136) (which is in the data node) handles the data compression functionality thereby not impacting the read/write performance and data processing performances of the data node (130A) and data processor (120, FIG. 1B). For additional details regarding the data compression performed by the CAD (136), see, e.g., FIG. 3B.

In one or more embodiments of the invention, the CAD (148) is a physical device that includes processing hardware (not shown) and memory (not shown). The CAD may include other elements/components without departing from the invention. The processing hardware may include, but is not limited to, a field-programmable gate array, application specific integrated circuit, programmable processor, microcontroller, digital signal processor, a host bus adapter (HBA) card, other processing hardware, or any combination thereof. Depending on the implementation, the CAD may also include persistent storage that may include computer readable instructions, which may be executed by the processing hardware, to perform all or a portion of the functionality of method shown in FIG. 3B. The memory may be, for example, Random Access Memory (RAM). The memory (or volatile storage) in the CAD may include a copy of the storage metadata (122, FIG. 1B). The processing hardware may be adapted to provide the functionality of the CAD (136) described throughout this application and/or all, or a portion thereof, of the methods illustrated in FIG. 3B.

In one or more embodiments of the invention, the persistent storage devices (138A, 138N) store processed data. The data may be data chunks and/or parity chunks, deduplicated data, compressed data, and/or replicated data. In addition, the data may also include storage metadata. The persistent storage devices (138A, 138N) may be non-volatile storage. In other words, the data stored in the persistent storage devices (138A, 138N) is not lost or removed when the persistent storage devices (138A, 138N) lose power. Each of the persistent storage devices (138A, 138N) may be, for example, solid state drives, hard disk drives, and/or tape drives. The persistent storage devices (138A, 138N) may include other types of non-volatile or non-transitory storage mediums without departing from the invention.

FIG. 1D shows a diagram of a data node with a non-volatile memory device in accordance with one or more embodiments of the invention. The data node (140) may be an embodiment of the data nodes (130A, 130N, FIG. 1B) discussed above. The data node (140) may include a processor (142), a non-volatile memory (NVM) device(s) (144), and one or more persistent storage devices (146A, 146N). Each component of the data node (140) may be operatively connected to each other via wired and/or wireless connections. The data node (140) may have additional, fewer, and/or different components without departing from the invention. Each of the illustrated components of the data node (140) is discussed below.

In one or more embodiments of the invention, the processor (142) is a component that processes data and processes requests. The processor (142) may be, for example, a central processing unit (CPU). The processor (142) may be other types of processors without departing from the invention. The processor (142) may process a request to store data and/or metadata and process data and/or metadata using data stored in memory (e.g., 144), the persistent storage devices (146A, 146N), and/or other data nodes (e.g., 130N, FIG. 1B). The processor may process requests to perform delayed compression on data that is de-staged from the NVM device (144). For additional information regarding delayed compression, refer to FIG. 3C. The processor (142) may process other requests without departing from the invention.

In one or more embodiments of the invention, the data node includes a NVM device (144) which stores data that is more accessible to the processor (142) than the persistent storage devices (138A, 138N) and the memory (134, FIG. 1C) described above. The NVM device (144) may be non-volatile storage. Non-volatile storage may be storage that stores data that is not lost when the storage loses power. The NVM device (144) may provide very fast read and write speeds. The NVM device (144) may be configured as a cache device. More specifically, the NVM device (144) may include a limited amount of storage capacity. When the NVM device (144) is full, the data within may be de-staged from the NVM device (144), compressed, and stored in the persistent storage devices (146A, 146N). The NVM device (144) may be, for example, persistent memory (PMEM). The NVM device (144) may be other types of storage devices that provide the aforementioned functionality without departing from the invention.

In one or more embodiments of the invention, the persistent storage devices (146A, 146N) store processed data. The processed data may be data chunks and/or parity chunks, deduplicated data, compressed data, and/or replicated data. In addition, the persistent storage device may also store storage metadata. The persistent storage devices (146A, 146N) may be non-volatile storage. In other words, the data and metadata stored in the persistent storage devices (146A, 146N) is not lost or removed when the persistent storage devices (146A, 146N) lose power. Each of the persistent storage devices (146A, 146N) may be, for example, solid state drives, hard disk drives, and/or tape drives. The persistent storage devices (146A, 146N) may include other types of non-volatile or non-transitory storage mediums without departing from the invention.

FIG. 1E shows a diagram of a data node with no hardware accelerators in accordance with one or more embodiments of the invention. The data node (150) may be an embodiment of the data nodes (130A, 130N, FIG. 1B) discussed above. The data node (150) may include a processor (152), memory (154), and one or more persistent storage devices (156A, 156N). Each component of the data node (150) may be operatively connected to each other via wired and/or wireless connections. The data node (150) may have additional, fewer, and/or different components without departing from the invention. Each of the illustrated components of the data node (150) is discussed below.

In one or more embodiments of the invention, the processor (152) is a component that processes data and processes requests. The processor (152) may be, for example, a central processing unit (CPU). The processor (152) may be other types of processors without departing from the invention. The processor (152) may process a request to store data and/or metadata and process data and/or metadata using data stored in memory (e.g., 154), the persistent storage devices (156A, 156N), and/or other data nodes (e.g., 130N, FIG. 1B). The processor (152) may process other requests without departing from the invention.

In one or more embodiments of the invention, the data node (150) includes memory (154), which stores data that is more accessible to the processor (152) than the persistent storage devices (156A, 156N). The memory (154) may be volatile storage. Volatile storage may be storage that stores data that is lost when the storage loses power. The memory (154) may be, for example, Random Access Memory (RAM). In one or more embodiments of the invention, a copy of the data and/or parity chunks required for a persistent storage device rebuilding operation are stored in the memory (154) of the data node (150).

In one or more embodiments of the invention, the persistent storage devices (156A, 156N) store processed data. The processed data may be data chunks and/or parity chunks, deduplicated data, compressed data, and/or replicated data. In addition, the persistent storage device may also store storage metadata. The persistent storage devices (156A, 156N) may be non-volatile storage. In other words, the data and metadata stored in the persistent storage devices (156A, 156N) is not lost or removed when the persistent storage devices (156A, 156N) lose power. Each of the persistent storage devices (156A, 156N) may be, for example, solid state drives, hard disk drives, and/or tape drives. The persistent storage devices (156A, 156N) may include other types of non-volatile or non-transitory storage mediums without departing from the invention.

FIG. 2 shows a diagram of storage metadata in accordance with one or more embodiments of the invention. The storage metadata (200) may be an embodiment of the storage metadata (122, FIG. 1B) discussed above. As discussed above, the storage metadata (200) includes information about processed data stored in the data cluster (e.g., 110, FIG. 1A). The storage information may include slice metadata (210), deduplication metadata (220), compression metadata (230), and replication metadata (240). Each of the aforementioned portions of storage metadata (200) is discussed below.

In one or more embodiments of the invention, slice metadata (210) includes metadata associated data and parity chunks of data slices generated during erasure coding operations. Each data slice may have an associated metadata slice entry (e.g., 212A, 212N) generated by the data processor (120, FIG. 1B) when the data slice was generated and stored across the persistent storage devices (e.g., 130A, 130N, FIG. 1B) of the data cluster (e.g., 110A, FIG. 1B). The metadata slice entry (212A, 212N) includes chunk metadata (214A, 214N). Each chunk of a chunk metadata (214A, 214N) may correspond to metadata for a data chunk or a parity chunk. Each chunk metadata (214A, 214N) may include information about a chunk such as, for example, a unique identifier (e.g., a fingerprint) that may be used to differentiate the chunks stored in the data cluster (110, FIG. 1A), a storage location of the chunk (e.g., the persistent storage device and data node in which the chunk is stored), and a data slice identifier that identifies the data slice in which the chunk is associated. The chunk metadata (214A, 214N) may include other and/or additional information regarding the chunks without departing from the invention. The slice metadata (210) may be used to combine chunks to regenerate data that was broken up into chunks during a erasure coding operation and/or to rebuild lost or corrupted data and/or parity chunks.

In one or more embodiments of the invention, deduplication metadata (220) includes metadata associated with deduplicated data generated during deduplication operations. The deduplication metadata (220) may include unique identifiers (e.g., fingerprints) for unique data chunks. The deduplication metadata (220) may also include mapping information. Mapping information may, for example, include information that indicates which unique chunks stored in the data cluster (e.g., 110, FIG. 1A) may make up a data file or other form of data that was deduplicated and includes one or more unique data chunks. The mapping information may also include the storage locations (e.g., the data node (e.g., 130A, FIG. 1C) and persistent storage device (e.g., 138A, FIG. 1C)) in which each unique data chunk is stored. The deduplication metadata (220) may include other and/or additional information regarding deduplicated data without departing from the invention. The deduplication metadata (220) may be used to undedupe deduplicated data.

In one or more embodiments of the invention, the compression metadata (230) includes metadata associated with compressed data generated during compression and/or delayed compression operations. The compression metadata (230) may include storage locations (e.g., the data node (e.g., 130A, FIG. 1C) and persistent storage device (e.g., 138A, FIG. 1C)), unique identifiers (e.g., fingerprints) and the associated algorithm used to compress the compressed data chunks. The compression metadata (230) may be used to decompress the compressed data. The compressed metadata (230) may include other and/or additional metadata regarding the compressed data without departing from the invention. The compression metadata (230) may be used to decompress compressed data.

In one or more embodiments of the invention, replication metadata (240) includes metadata associated with replicas generated during replication operations. Replicas may be copies of data obtained from a host (e.g., 100, FIG. 1A) generated during a replication operations. The replication metadata (240) may include unique identifiers of replicas (e.g., fingerprints), the identifiers of the original data associated with the replicas, and the storage locations (e.g., the data node (e.g., 130A, FIG. 1C) and persistent storage device (e.g., 138A, FIG. 1C)) of the replicas. The replication metadata (240) may be used to obtain replicas of corrupted or unavailable data. The replication metadata (240) may include other and/or additional metadata regarding replicas without departing from the invention.

FIG. 3A shows a flowchart for storing data in accordance with one or more embodiments of the invention. The method shown in FIG. 3A may be performed by, for example, a data processor (120, FIG. 1B). Other components of the system illustrated in FIG. 1B may perform the method of FIG. 3A without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 300, data is obtained from a host. The data may be a file, a file segment, a collection of files, or any other type of data without departing from the invention. The obtained data may include one or more protection policies associated with the host.

In step 302, protection policies associated with the host are checked. In one or more embodiments of the invention, the protection policies associated with the host indicate whether the replication or erasure coding should be performed on the data obtained in step 300. The data processor may check the protection policies to determine whether to perform a replication operation or an erasure coding operation.

In step 304, a determination is made as to whether the hardware of the data cluster includes hardware accelerators. If the underlying hardware includes hardware accelerators, the method may proceeds to step 306; otherwise, the method proceeds to step 308. In one or more embodiments of the invention, the data nodes include hardware accelerators that enable the data processor to perform additional data processing operations.

In step 306, in response to the determination of step 304 that the hardware of the data cluster includes hardware accelerators, the appropriate storage of data obtained from the host based on the protection policies and the underlying hardware accelerators is initiated. The data processor may initiate one or more data processing operations on the obtained data using the hardware accelerators based on the protection policies prior to storing the data in the data nodes of the data cluster. For additional details regarding the appropriate storage of data obtained from the host based on the protection policies and the underlying hardware accelerators, refer to FIGS. 3B-3C.

The method may end following step 306.

In step 308, in response to the determination of step 304 that the hardware does not include hardware accelerators, the appropriate storage of data obtained from the host based on the protection policies is initiated. In one or more embodiments of the invention, the data nodes do not have hardware accelerators. The data processor may not perform or initiate the data processing operations due to the lack of hardware accelerators. For addition details regarding the initiation of the appropriate storage of data obtained from the host based on the protection policies, refer to FIG. 3D.

The method may end following step 308.

FIGS. 3B and 3C show flowcharts for storing data in a system that includes hardware accelerators in accordance with one or more embodiments of the invention. The method shown in FIGS. 3B and 3C may be performed by, for example, a data processor (120, FIG. 1B). Other components of the system illustrated in FIG. 1B may perform the method of FIGS. 3B and 3C without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to FIG. 3B, in step 310, a determination is made as to whether the hardware includes CADs. In one or more embodiments of the invention, the hardware accelerators include CADs or NVM devices. If the hardware includes CADs, the method proceeds to step 312. If the hardware does not include CADs, the method proceeds to step 330 of FIG. 3C.

Continuing with the discussion of FIG. 3B, in step 312, a determination is made as to whether the protection policies are set to replication. In one or more embodiments of the invention, one or more of the protection policies indicate whether to perform replication or erasure coding on the data obtained from the host. If the protection policies are set to replication, then the method proceeds to step 314. If the protection policies are not set to replication (i.e., set to erasure coding), the method proceeds to step 318.

In step 314, the obtained data is replicated and the resulting replicas are sent to the data nodes. In one or more embodiments of the invention, replication includes copying the data obtained from the host to generate replicas. The data processor may perform the replication operation on the obtained data and upon completing the replication operation, may then send the replicas to the data nodes of the data cluster. The protection policies may include the number of replicas to be generated during the replication operation. There may be any number of replicas generated and sent to the data nodes of the data cluster without departing from the invention. The replicas may be sent to the CADs of the data nodes. The data processor may generate storage metadata during the replication operation. The storage metadata may include replication metadata.

In step 316, the compression of the replicas on the CADs is initiated. In one or more embodiments of the invention, the data processor initiates compression of the replicas on the CADs. The data processor may send a request to the CADs of the data nodes. After receiving the request, the CADs may then perform a compression operation on the replicas. Upon completion of the compression operation, the CADs may then store the compressed replicas in persistent storage devices. The CADs may generate storage metadata during the compression operation. The storage metadata may include compression metadata. The CADs may send the storage metadata to the data processor.

The method may end following step 316.

In step 318, in response to the determination that the protection policies are not set to replication (i.e., set to erasure coding) erasure coding is performed on the data to obtain chunks (i.e., data and parity chunks). In one or more embodiments of the invention, the erasure coding procedure includes dividing the obtained data into portions, referred to as data chunks. Each data chunk may include any number of data segments associated with the obtained data. The individual data chunks may then be combined (or otherwise grouped) into slices (also referred to as Redundant Array of Independent Disks (RAID) slices). One or more parity chunks are generated based on the erasure coding algorithm. The number of parity chunks may vary based on the erasure coding algorithm that is being used as part of the erasure coding procedure.

In one or more embodiments of the invention, the number of data chunks and parity chunks generated is determined by the erasure coding procedure, which may be specified by the host, by the data cluster, and/or by another entity.

In step 320, deduplication is performed on the chunks and the unique chunks are sent to the data nodes. The data processor performing the deduplication may generate a fingerprint for a data chunk and identify whether the fingerprint matches an existing fingerprint stored in storage metadata (i.e., deduplication metadata). If the fingerprint matches an existing fingerprint, the data chunk may be deleted, as it is already stored in the data cluster. If the fingerprint does not match any existing fingerprints, the data chunk may be stored as a deduplicated data chunk. Additionally, the fingerprint of each deduplicated data chunk is stored in a storage metadata slice entry of the storage metadata. A fingerprint (or other unique identifier) of each parity chunk is also generated and stored in the storage metadata slice entry.

In one or more embodiments of the invention, the deduplicated data chunks collectively make up the deduplicated data. In one or more embodiments of the invention, the deduplicated data chunks are the data chunks that were not deleted during deduplication.

In step 322, compression of the unique chunks is initiated on the CADs. In one or more embodiments of the invention, the data processor initiates compression of the replicas on the CADs. The data processor may send a request to the CADs of the data nodes. After receiving the request, the CADs may then perform a compression operation on the replicas. Upon completion of the compression operation, the CADs may then store the compressed replicas in persistent storage devices. The CADs may generate storage metadata during the compression operation. The storage metadata may include compression metadata. The CADs may send the storage metadata to the data processor.

The method may end following step 322.

Turning to FIG. 3C, in step 330, in response to the determination of step 310 that the hardware does not include CADs, and therefore, includes NVM devices, a determination is made as to whether the protection policy is set to replication. In one or more embodiments of the invention, one or more of the protection policies indicate whether to perform replication or erasure coding on the data obtained from the host. If the protection policies are set to replication, then the method proceeds to step 332. If the protection policies are not set to replication (i.e., set to erasure coding), the method proceeds to step 336.

In step 332, replication is performed on the obtained data and the replicas are sent to the NVM device of the data nodes. In one or more embodiments of the invention, replication includes copying the data obtained from the host to generate replicas. The data processor may perform the replication operation on the obtained data and upon completing the replication operation, may then send the replicas to the data nodes in the data cluster. The protection policies may include the number of replicas to be generated during the replication operation. There may be any number of replicas generated and sent to the data nodes of the data cluster without departing from the invention. The replicas may be sent to the NVM devices of the data nodes. The data processor may generate storage metadata during the replication operation. The storage metadata may include replication metadata.

In step 334, delayed compression of the replicas when the replicas are de-staged from the NVM devices to persistent storage devices. In one or more embodiments of the invention, one or more of the replicas are de-staged from the NVM devices when the NVM devices reach capacity. When this occurs, the data processor may send a request to the data nodes to initiate delayed compression.

In one or more embodiments of the invention, delayed compression is the persistent storage device may also store performance of a compression operation when the replicas de-stage from the NVM devices to the persistent storage devices of the data nodes. The replicas may reside in the NVM devices decompressed until the capacity of the NVM devices is exceeded. Upon exceeding NVM device capacity, the data node may obtain at least one of the replicas from the NVM device (i.e., the NVM device that has reached capacity), compress the obtained replica and store the compressed replica in a persistent storage device. Once the compressed replica is stored on the persistent storage device, the decompressed replica is remove (or deleted) from the NVM device.

The method may end following step 334.

In step 336, in response to the determination of step 330, that the protection policies are not set to replication (i.e., set to erasure coding), erasure coding is performed on the data to obtain chunks and the chunks are sent to the NVM devices of the data nodes. In one or more embodiments of the invention, the erasure coding procedure includes dividing the obtained data into portions, referred to as data chunks. Each data chunk may include any number of data segments associated with the obtained data. The individual data chunks may then be combined (or otherwise grouped) into slices (also referred to as Redundant Array of Independent Disks (RAID) slices). One or more parity chunks are generated based on the erasure coding algorithm. The number of parity chunks may vary based on the erasure coding algorithm that is being used as part of the erasure coding procedure.

In one or more embodiments of the invention, the number of data chunks and parity chunks generated is determined by the erasure coding procedure, which may be specified by the host, by the data cluster, and/or by another entity.

In step 338, delayed compression of the chunks is initiated when the chunks de-stage from the NVM devices to persistent storage devices. In one or more embodiments of the invention, one or more of the chunks are de-staged from the NVM devices when the NVM devices reach capacity. The data processor may send a request to the data nodes to initiate delayed compression.

In one or more embodiments of the invention, delayed compression is the performance of a compression operation when the chunks de-stage from the NVM devices to the persistent storage devices of the data nodes. The chunks may reside in the NVM devices decompressed until the capacity of the NVM devices is exceeded. Upon exceeding NVM device capacity, the data node may obtain at least one of the chunks from the NVM device (i.e., the NVM device that has reached capacity), compress the chunk(s) and store the compressed chunk(s) in persistent storage devices. Once the compressed chunk(s) is stored on the persistent storage device, the decompressed chunk(s) is remove (or deleted) from the NVM device.

The method may end following step 338.

FIG. 3D shows a flowchart for storing data in a system that does not include hardware accelerators in accordance with one or more embodiments of the invention. The method shown in FIG. 3D may be performed by, for example, a data processor (120, FIG. 1B). Other components of the system illustrated in FIG. 1B may perform the method of FIG. 3D without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 340, a determination is made as to whether the protection policy is set to replication. In one or more embodiments of the invention, one or more of the protection policies indicate whether to perform replication or erasure coding on the data obtained from the host. If the protection policies are set to replication, then the method proceeds to step 342. If the protection policies are not set to replication (i.e., set to erasure coding), the method proceeds to step 346.

In step 342, the obtained data is replicated to generate replicas. In one or more embodiments of the invention, replication includes copying the data obtained from the host to generate replicas. The data processor may perform the replication operation on the obtained data and upon completing the replication operation, may then send the replicas to the data nodes of the data cluster. The protection policies may include the number of replicas to be generated during the replication operation. There may be any number of replicas generated and sent to the data nodes of the data cluster without departing from the invention. The replicas may be sent to the persistent storage devices of the data nodes. The data processor may generate storage metadata during the replication operation. The storage metadata may include replication metadata.

In step 344, deduplication is performed on the replicas and the unique and necessary replicas are sent to the data nodes. The data processor performing the deduplication may generate a fingerprint for a data chunk of the replicas and identify whether the fingerprint matches an existing fingerprint stored in storage metadata (i.e., deduplication metadata). If the fingerprint matches an existing fingerprint, the data chunk may be deleted, as it is already stored in the data cluster. If the fingerprint does not match any existing fingerprints, the data chunk may be stored as a deduplicated data chunk. Additionally, the fingerprint of each deduplicated data chunk is stored in a storage metadata slice entry of the storage metadata.

In one or more embodiments of the invention, the deduplicated data chunks collectively make up the deduplicated data. In one or more embodiments of the invention, the deduplicated data chunks are the data chunks that were not deleted during deduplication.

The method may end following step 344.

In step 346, erasure coding is performed on the data to obtain chunks. In one or more embodiments of the invention, the erasure coding procedure includes dividing the obtained data into portions, referred to as data chunks. Each data chunk may include any number of data segments associated with the obtained data. The individual data chunks may then be combined (or otherwise grouped) into slices (also referred to as Redundant Array of Independent Disks (RAID) slices). One or more parity chunks are generated based on the erasure coding algorithm. The number of parity chunks may vary based on the erasure coding algorithm that is being used as part of the erasure coding procedure.

In one or more embodiments of the invention, the number of data chunks and parity chunks generated is determined by the erasure coding procedure, which may be specified by the host, by the data cluster, and/or by another entity.

In step 348, deduplication is performed on the chunks and the unique chunks are sent to the data nodes. The data processor performing the deduplication may generate a fingerprint for a data chunk and identify whether the fingerprint matches an existing fingerprint stored in storage metadata (i.e., deduplication metadata). If the fingerprint matches an existing fingerprint, the data chunk may be deleted, as it is already stored in the data cluster. If the fingerprint does not match any existing fingerprints, the data chunk may be stored as a deduplicated data chunk. Additionally, the fingerprint of each deduplicated data chunk is stored in a storage metadata slice entry of the storage metadata. A fingerprint (or other unique identifier) of each parity chunk is also generated and stored in the storage metadata slice entry.

In one or more embodiments of the invention, the deduplicated data chunks collectively make up the deduplicated data. In one or more embodiments of the invention, the deduplicated data chunks are the data chunks that were not deleted during deduplication.

The method may end following step 346.

### Example

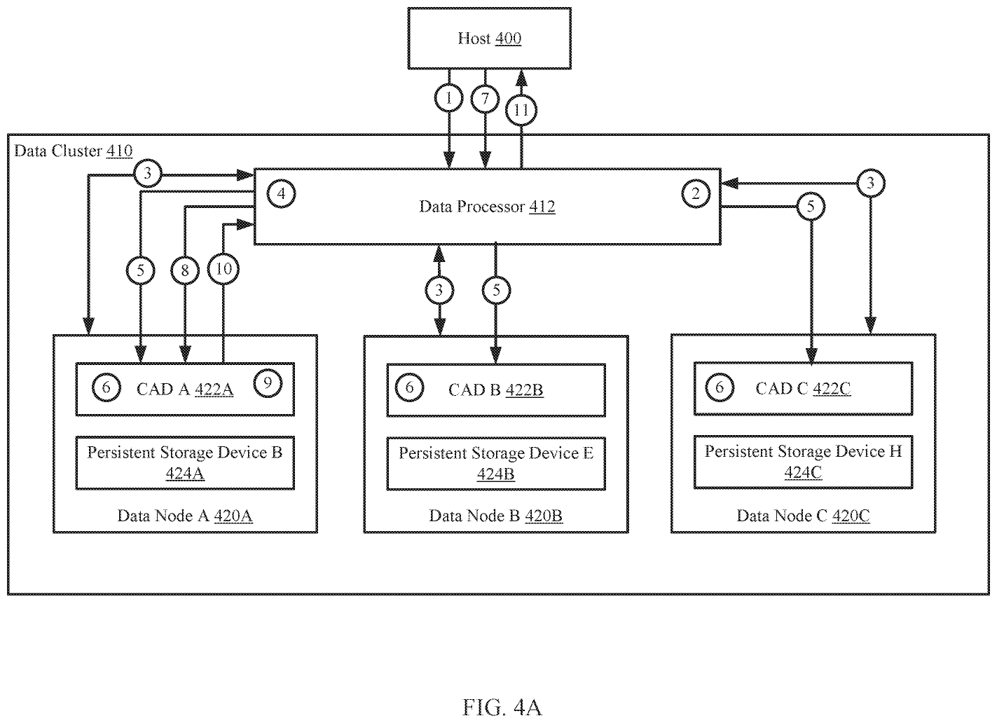

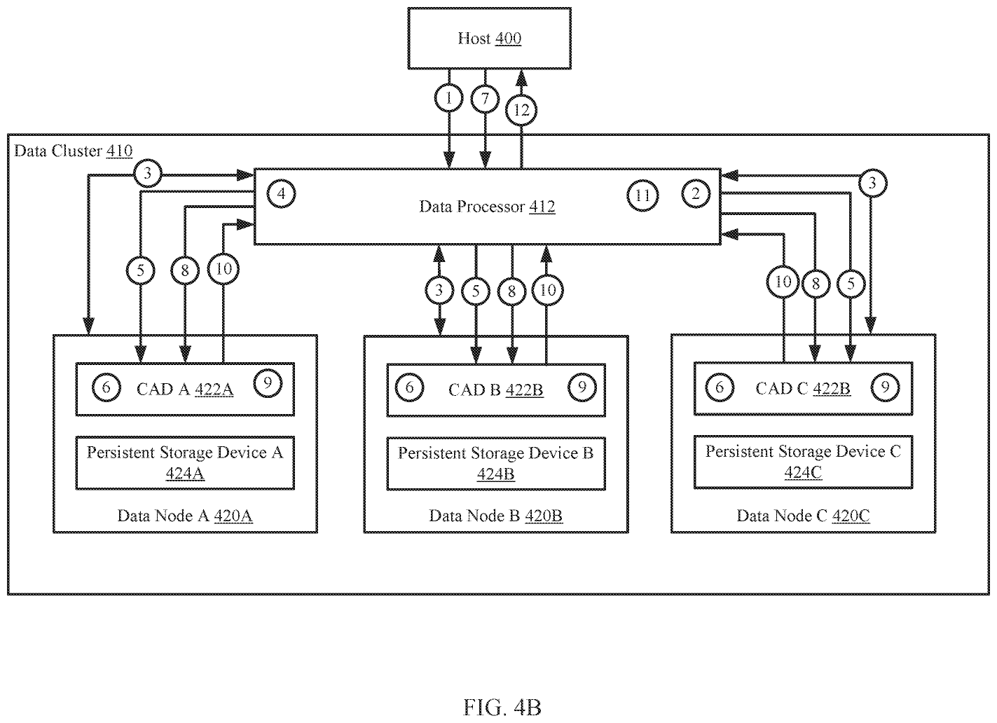

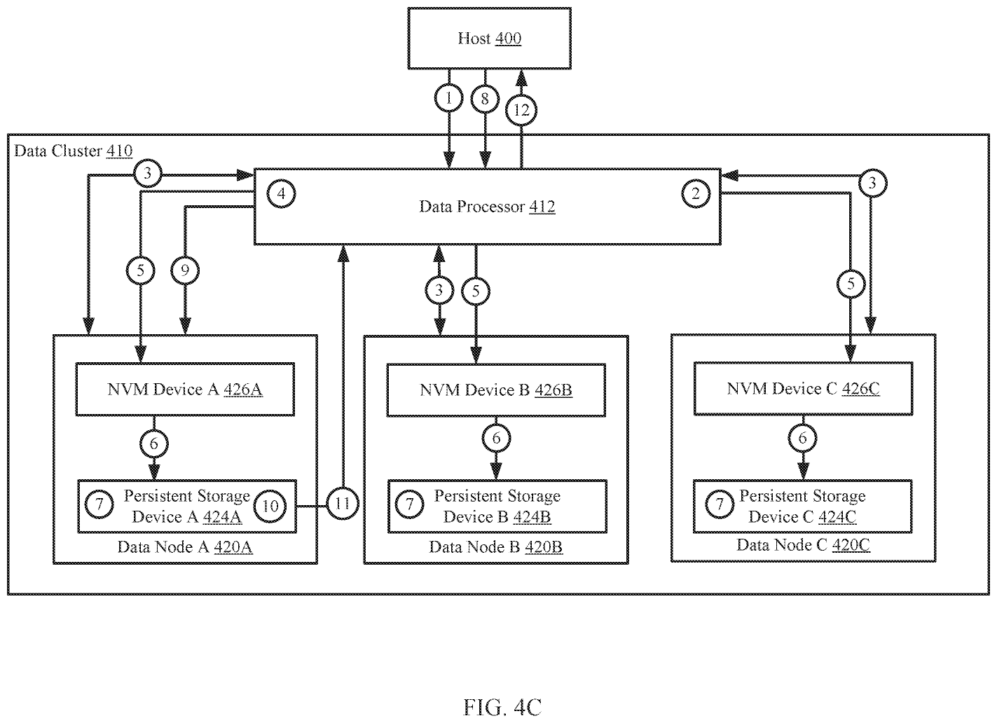

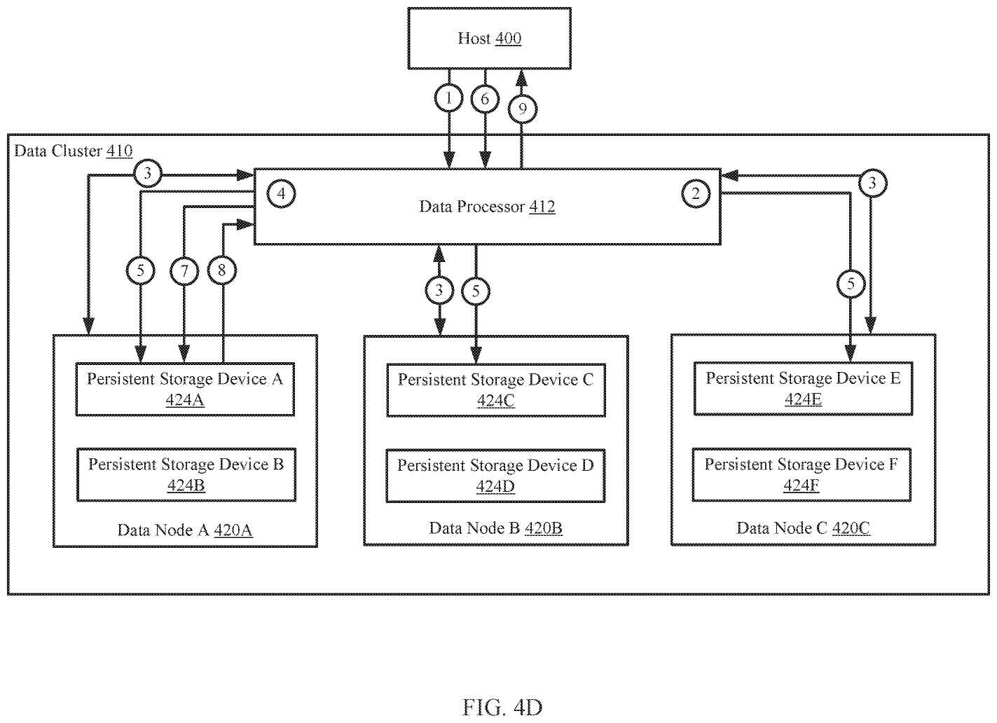

FIGS. 4A-4D show examples in accordance with one or more embodiments of the invention. The examples are not intended to limit the invention. FIG. 4A shows a first example. Turning to the first example, consider a scenario in which a data cluster obtains data from a host. The data is a file. FIG. 4A shows a diagram of a first example system in accordance with one or more embodiments of the invention. The host (400) sends data to a data processor (412) of a data cluster (410) [1]. The data processor (412) checks the protection policies associated with the host (400) and determines that the protection policies are set to replication [2]. The data processor (412) then sends a request to check the underlying hardware of the data nodes (420A, 420B, 420C) of the data cluster (410). In response to the request, the data nodes (420A, 420B, 420C) notify the data processor (412) that they include hardware accelerators in the form of CADs (422A, 422B, 422C) [3]. The data processor (412) then performs replication on the data obtained from the host (400) to generate three replicas [4].

The data processor (412) then sends each of the replicas to the CADs (422A, 422B, 422C) of the data nodes (420A, 420B, 420C) and initiates compression [5]. The CADs (422A, 422B, 422C) perform compression on the replicas and store the compressed replicas [6]. At a later point in time, the host (400) sends a request to the data processor (412) to obtain the data it previously sent [7]. The data processor (412) then sends a request to CAD A (422A) to decompress the compressed replica stored within and send the decompressed replica to the data processor (412) [8]. CAD A (422A) decompresses the compressed replica [9]. CAD A (422A) then sends the decompressed replica to the data processor (412) [10]. After obtaining the decompressed replica, the data processor (412) sends the decompressed replica (or a portion thereof) to the host (400) [11].

FIG. 4B shows a second example. Turning to the second example, consider a scenario in which a data cluster obtains data from a host. The data is a file. FIG. 4B shows a diagram of a second example system in accordance with one or more embodiments of the invention. The host (400) sends data to a data processor (412) of a data cluster (410) [1]. The data processor (412) checks the protection policies associated with the host (400) and determines that the protection policies are set to erasure coding [2]. The data processor (412) then sends a request to check the underlying hardware of the data nodes (420A, 420B, 420C) of the data cluster (410). In response to the request, the data nodes (420A, 420B, 420C) notify the data processor (412) that they include hardware accelerators in the form of CADs (422A, 422B, 422C) [3]. The data processor (412) then performs 2:1 erasure coding and deduplication on the data obtained from the host (400) to generate three deduplicated chunks [4]. Two of the chunks are data chunks and one of the chunks is a parity chunk.

The data processor (412) then sends each of the chunks to the CADs (422A, 422B, 422C) of the data nodes (420A, 420B, 420C) and initiates compression [5]. The CADs (422A, 422B, 422C) perform compression on the chunks and store the compressed chunks [6]. At a later point in time, the host (400) sends a request to the data processor (412) to obtain the data it previously sent [7]. The data processor (412) then sends a request to the CADs (422A, 422B, 422C) to decompress the compressed chunks stored within and send the decompressed chunks to the data processor (412) [8]. The CADs (422A, 422B, 422C) decompress the compressed chunks [9]. The CADs (422A, 422B, 422C) then send the decompressed chunks to the data processor (412) [10]. After obtaining the decompressed chunks, the data processor (412) assembles the chunks into the original file [11]. The data processor (412) then sends the file to the host (400) [12].

FIG. 4C shows a third example. Turning to the third example, consider a scenario in which a data cluster obtains data from a host. The data is a file. FIG. 4C shows a diagram of a third example system in accordance with one or more embodiments of the invention. The host (400) sends data to a data processor (412) of a data cluster (410) [1]. The data processor (412) checks the protection policies associated with the host (400) and determines that the protection policies are set to replication [2]. The data processor (412) then sends a request to check the underlying hardware of the data nodes (420A, 420B, 420C) of the data cluster (410). In response to the request, the data nodes (420A, 420B, 420C) notify the data processor (412) that they include hardware accelerators in the form of NVM devices (426A, 426B, 426C) [3]. The data processor (412) then performs replication on the data obtained from the host (400) to generate three replicas [4].

The data processor (412) then sends each of the replicas to the NVM devices (426A, 426B, 426C) of the data nodes (420A, 420B, 420C) and initiates delayed compression [5]. At a later point in time, the NVM devices reach capacity and the replicas are de-staged from the NVM devices and are sent to the persistent storage devices (424A, 424B, 424C) [6]. The data nodes (420A, 420B, 420C) perform delayed compression on the replicas and store the compressed replicas in the persistent storage devices (424A, 424B, 424C) and delete the uncompressed replicas from the NVM devices [7]. At a later point in time, the host (400) then sends a request to the data processor (412) to obtain the data it previously sent [8]. The data processor (412) then sends a request to data node A (420A) to decompress the compressed replica stored within and send the decompressed replica to the data processor (412) [9]. Data node A (420A) decompresses the compressed replica and stores the decompressed replica in NVM Device A (426A) [10]. Data node A (420A) then sends the decompressed chunks to the data processor (412) [11]. The data processor (412) then sends the replica (or a portion thereof) to the host (400) [12].

FIG. 4D shows a fourth example. Turning to the fourth example, consider a scenario in which a data cluster obtains data from a host. The data is a file. FIG. 4D shows a diagram of a fourth example system in accordance with one or more embodiments of the invention. The host (400) sends data to a data processor (412) of a data cluster (410) [1]. The data processor (412) checks the protection policies associated with the host (400) and determines that the protection policies are set to replication [2]. The data processor (412) then sends a request to check the underlying hardware of the data nodes (420A, 420B, 420C) of the data cluster (410). In response to the request the data nodes (420A, 420B, 420C) notify the data processor (412) that they do not include hardware accelerators [3]. The data processor (412) then performs replication and deduplication on the data obtained from the host (400) to generate two deduplicated replicas [4]. The third deduplicated replica is not generated as there are already two deduplicated replicas, one of which is unique and the other is generated to satisfy the replication protection policies.

The data processor (412) then sends a replicas to each of persistent storage devices A and C (424A, 424C) of data nodes A and B (420A, 420B), where the replicas are subsequently stored in the persistent storage devices (424A, 424C) [5]. At a later point in time, the host (400) sends a request to the data processor (412) to obtain the data it previously sent [6]. The data processor (412) then sends a request to data node A (420A) to send the replica stored in persistent storage device A (424A) [7]. Data node A (420A) then sends the replica to the data processor (412) [8]. The data processor (412) then sends the replica to the host (400) [9].

### End of Example

As discussed above, embodiments of the invention may be implemented using computing devices. FIG. 5 shows a computing system in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention improve the efficiency of storing data and decrease the computational resources required to store data a data cluster. In one embodiment of the invention, the efficiency is improved and the computational resources required are decreased by offloading one or more data processing operations from a data processor to hardware accelerators included in the data cluster with minimal impact on the performance of the data storage operations of the data cluster. The hardware accelerators may be compute acceleration devices or non-volatile memory devices. The data processing operations may include replication, erasure coding, compression, and deduplication. More specifically, the data processor may initiate a compression operation on one or more compute acceleration devices, and initiate compression in a data node of a data cluster when data de-stages from a non-volatile memory device.

In traditional data clusters, a data processor may perform the compression operations along with replication, deduplication, and/or erasure coding, resulting in increased computational overhead. Embodiments of the invention improve the traditional data clusters by offloading some of the data processing from the data processor to the underlying hardware of the data cluster. As a result, the latency and computational efficiency required to store data in a data cluster are improved.

Thus, embodiments of the invention may address the problem of inefficient use of computing resources. This problem arises due to the technological nature of the environment in which data is stored.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

1. A method for storing data, the method comprising:
obtaining host data from a host;
making a first determination that a data cluster comprises a plurality of non-volatile memory devices;
based on the first determination:
storing processed data corresponding to the host data in at least one of the plurality of non-volatile memory devices, wherein the processed data is generated based on a protection policy specifying requirements for generating and storing the processed data associated with the host data; and
making a second determination to de-stage at least a portion of the processed data to a persistent storage device; and
based on the second determination, initiating a delayed compression operation on the processed data.

2. The method of claim 1, wherein the delayed compression operation comprises:
compressing at least a portion of the processed data to obtain compressed data; and
initiating transmission of the compressed data to the persistent storage device.

3. The method of claim 1, wherein storing the processed data corresponding to the host data in at least one of the plurality of non-volatile memory devices comprising:
performing an erasure coding operation on at least a portion of the host data to generate processed data; and
initiating transmission of the processed data to the at least one of the plurality of non-volatile memory devices.

4. The method of claim 3, wherein performing the erasure coding operation comprises generating at least one parity value using at least a portion of the host data.

5. The method of claim 1, wherein storing the processed data corresponding to the host data in at least one of the plurality of non-volatile memory devices comprising:
performing a replication operation on at least a portion of the host data to generated processed data; and
initiating transmission of the processed data to the at least one of the plurality of non-volatile memory devices.

6. The method of claim 1, wherein the data cluster comprises at least one node, wherein the at least one of the plurality of non-volatile memory devices and the persistent storage device are located on the at least one node.

7. The method of claim 1, wherein making the second determination to de-stage at least a portion of the processed data to the persistent storage device comprises:
making a third determination that a storage threshold for the at least one of the plurality of non-volatile memory devices has been exceeded.

8. A system, comprising:
a processor;
a data processor, which when executed by the processor performs a method, the method comprising:
obtaining host data from a host;
making a first determination that a data cluster comprises a plurality of non-volatile memory devices;
based on the first determination:
storing processed data corresponding to the host data in at least one of the plurality of non-volatile memory devices, wherein the processed data is generated based on a protection policy specifying requirements for generating and storing the processed data associated with the host data; and
making a second determination to de-stage at least a portion of the processed data to a persistent storage device; and
based on the second determination, initiating a delayed compression operation on the processed data.

9. The system of claim 8, wherein the delayed compression operation comprises:
compressing at least a portion of the processed data to obtain compressed data; and
initiating transmission of the compressed data to the persistent storage device.

10. The system of claim 8, wherein storing the processed data corresponding to the host data in at least one of the plurality of non-volatile memory devices comprising:
performing an erasure coding operation on at least a portion of the host data to generate processed data; and
initiating transmission of the processed data to the at least one of the plurality of non-volatile memory devices.

11. The system of claim 10, wherein performing the erasure coding operation comprises generating at least one parity value using at least a portion of the host data.

12. The system of claim 8, wherein storing the processed data corresponding to the host data in at least one of the plurality of non-volatile memory devices comprising:
performing a replication operation on at least a portion of the host data to generated processed data; and
initiating transmission of the processed data to the at least one of the plurality of non-volatile memory devices.

13. The system of claim 8, wherein the data cluster comprises at least one node, wherein the at least one of the plurality of non-volatile memory devices and the persistent storage device are located on the at least one node.

14. The system of claim 8, wherein making the second determination to de-stage at least a portion of the processed data to the persistent storage device comprises:
making a third determination that a storage threshold for the at least one of the plurality of non-volatile memory devices has been exceeded.

15. A non-transitory computer readable medium comprising computer readable program code, which when executed by a computer processor enables the computer processor to perform a method, the method comprising:
obtaining host data from a host;
making a first determination that a data cluster comprises a plurality of non-volatile memory devices;
based on the first determination:
storing processed data corresponding to the host data in at least one of the plurality of non-volatile memory devices, wherein the processed data is generated based on a protection policy specifying requirements for generating and storing the processed data associated with the host data; and
making a second determination to de-stage at least a portion of the processed data to a persistent storage device; and
based on the second determination, initiating a delayed compression operation on the processed data.

16. The non-transitory computer readable medium of claim 15, wherein the delayed compression operation comprises:
compressing at least a portion of the processed data to obtain compressed data; and
initiating transmission of the compressed data to the persistent storage device.

17. The non-transitory computer readable medium of claim 15, wherein storing the processed data corresponding to the host data in at least one of the plurality of non-volatile memory devices comprising:
performing an erasure coding operation on at least a portion of the host data to generate processed data; and
initiating transmission of the processed data to the at least one of the plurality of non-volatile memory devices.

18. The non-transitory computer readable medium of claim 17, wherein performing the erasure coding operation comprises generating at least one parity value using at least a portion of the host data.

19. The non-transitory computer readable medium of claim 15, wherein storing the processed data corresponding to the host data in at least one of the plurality of non-volatile memory devices comprising:
performing a replication operation on at least a portion of the host data to generated processed data; and
initiating transmission of the processed data to the at least one of the plurality of non-volatile memory devices.

20. The non-transitory computer readable medium of claim 15, wherein the data cluster comprises at least one node, wherein the at least one of the plurality of non-volatile memory devices and the persistent storage device are located on the at least one node.
